(19) United States
(12) Patent Application Publication
(10) Pub. No.: US 2006/0169343 A1
(43) Pub. Date: Aug. 3, 2006

(54) Plastics pipe

(76) Inventors: Jeremy Bowman, Chesterfield (GB); Patrick Leevers, London (GB)

Correspondence Address: FISH & RICHARDSON PC, P.O. BOX 1022, MINNEAPOLIS, MN, 55440-1022, US

(21) Appl. No.: 10/525,184

(22) PCT Filed: Aug. 19, 2003
(86) PCT No.: PCT/GB03/03614

§ 371 Date: Aug. 29, 2005

(30) Foreign Application Priority Data
Aug. 19, 2002 (GB) 0219274.8

(51) Int. Cl. F16L 11/00

(52) U.S. Cl. 138/137; 138/141; 138/146; 428/36.91; 264/173.16

(57) ABSTRACT

A plastics pipe which comprises an inner core and an outer removable skin layer bonded thereto, wherein the inner core and the outer removable skin layer comprise polymeric materials chosen to have matching Young's moduli, such that the Young's modulus of the skin layer is equal to or less than the Young's modulus of the inner core, and the adhesion of the skin layer to the inner core is sufficient to prevent substantial undesired relative movement between the skin layer and the core during installation, but insufficient to prevent the outer skin layer from being cleanly removed by peeling, at least at the ends of the pipe, and insufficient to cause a substantial reduction in the impact strength of the inner core.

This invention relates to plastic pipes and more particularly to a novel composite plastics pipe, a method for its manufacture, and a method for making joints in such a pipe.

In the handling, installation and connection of plastics pipes, the pipe surface is easily damaged. In “no-dig” plastics pipe installation techniques, for example, a tunnel is bored in the ground for the pipe and the pipe is then pushed or pulled through the tunnel into an excavated hole where the next pipe joint is to be made. Installation techniques such as pipe-bursting and slip lining can also place extreme stress on the pipe surface.

Other modern pipe laying methods can also subject the pipe to substantial bending and tensile forces, both of which can result in a deterioration of the mechanical strength of the pipe. In addition, the useful life of the pipe may be reduced by diffusible materials in the ground, or by environment conditions, for example, exposure to direct sunlight for long periods.

Of greatest concern, is that modern pipe laying methods can result in the pipe becoming scratched and dirty. This is disadvantageous firstly as the pipe material may be notch sensitive, in which case any scratches may cause greater damage to occur in the pipe during subsequent handling or use. Secondly, dirt and/or oxidation on the pipe surface prevent successful welding. The main reason for failure of joints using an electrofusion coupler is that the surface of the pipe is dirty or has become oxidised. For this reason, until recently, the pipe ends always have had to be cleaned and scraped before jointing, for exampLe, with a hand or mechanical scraper. In practice, the cleaning and scraping is often uneven (the underside of the pipe in particular may be treated less carefully) and the quality of the end result depends upon the professional skill of the installer.

In recent years there have been proposals to provide the pipe with a non-adherent skin layer which can be removed in order to permit jointing. Composite pipe constructions of this type are described, for example, in JP3-24392, EP0474583, EP0604907, GB2323556, GB2300456, and WO93/00212. The entire disclosures of all these patents are incorporated herein by reference for all purposes.

All of these prior art pipe constructions suffer from the disadvantage that modern pipe laying techniques tend to cause wrinkling, rucking, or at least undesired movement of the non-adherent skin layer relative to the core when the pipe is pushed through the ground. These proposals have therefore not proved commercially acceptable.

More traditional proposals, wherein a protective skin layer is provided which is strongly adherent to the pipe, do not, of course, overcome the problem of dirt and oxidation on the outer surface, since such skin layers are very difficult to remove without elaborate equipment. The presence of a tightly adherent skin layer can also dramatically lower the impact strength of the plastics pipe.

The first appreciation that the above problems could be solved by using a protective skin layer which is only lightly adherent to the core pipe occurs in GB2297137 and GB2297138, the entire disclosures of which are incorporated herein by reference for all purposes.

In GB2297138, for example, there is provided a plastics pipe which comprises an inner core and an outer protective layer bonded thereto, in which the dimensions of the pipe and the protective layer are such that the ratio of the external diameter of the pipe to the thickness of the protective layer is at least 70, preferably at least 100, and the cohesive strength of the outer protective layer, excluding any lines of weakness, at least at the ends of the pipe, is greater than the strength of the adhesive bond between the outer protective layer and the inner core. According to this specification, by a correct choice of the material of the skin layer and the extrusion conditions, it is possible to provide a level of adhesion which still permits clean removal of the skin layer by peeling, whilst preventing rucking or wrinkling of the skin layer during installation and without substantially adversely affecting the mechanical properties of the pipe.

The composite pipe of UK patents GB2297137 and GB2297138 has been commercially extremely successful, but it has been found that under specific conditions of temperature and loading it is difficult to provide a skin layer which has both the required toughness and limited adhesion to the core pipe. Quality control of the base polymer material of the skin layer, and control of the extrusion conditions during manufacture, need to be rigorously maintained if undesirable quantities of scrap are to be avoided. This substantially increases both raw material and manufacturing costs.

It has now surprisingly been discovered that a substantial improvement in the impact strength of the composite pipe can be obtained by matching certain physical and mechanical properties of the polymeric materials of the core pipe and the skin layer.

In a first aspect, the invention provides a plastics pipe which comprises an inner core and an outer removable skin layer bonded thereto,

wherein the inner core and the outer removable skin layer comprise polymeric materials chosen to have matching Young's moduli, such that the Young's modulus of the skin layer is equal to or less than the Young's modulus of the inner core,

and the adhesion of the skin layer to the inner core is sufficient to prevent substantial undesired relative movement between the skin layer and the core during installation, but insufficient to prevent the outer skin layer from being cleanly removed by peeling, at least at the ends of the pipe, and insufficient to cause a substantial reduction in the impact strength of the inner core.

In a further aspect, the invention provides a method for the production of a plastics pipe comprising an inner core and an outer removable skin layer bonded thereto, the inner core and the outer removable skin layer comprising polymeric materials chosen to have matched Young's moduli, such that the Young's modulus of the skin layer is equal to or less than the Young's modulus of the inner core, which method comprises co-extruding molten polymeric materials forming the inner core and the outer removable skin layer from one or more extruder dies, bringing the molten polymeric materials together and allowing them to cool, such that, on cooling, the adhesion of the skin layer to the inner core is sufficient to prevent substantial undesired relative movement between the skin layer and the core during installation of the pipe, but insufficient to prevent the skin layer from being cleanly removed by peeling, at least at the ends of the pipe, and insufficient to cause a substantial reduction in the impact strength of the inner core.

In another aspect the invention provides a method of making a joint to a plastics pipe according to the first aspect of the invention, or of joining two such plastics pipes, which comprises peeling the skin layer from the region or regions of the pipe to be joined, to expose a clean surface suitable for electrofusion jointing, installing an electrofusion coupler over the clean surface or surfaces of the pipe or pipes and activating the electrofusion coupler to fuse the region or regions of the pipe or pipes thereto.

By “undesired relative movement” in this specification is meant movement or de-bonding of the skin layer relative to the core during directional drilling, pipe bursting, slip lining, or other conventional pipe installation procedures.

By selecting the polymeric materials of the inner core and the skin layer on the basis of matching their Young's moduli, we have found that it is possible to improve greatly the consistency of the resultant pipe without sacrificing quality and performance. Thus the properties of the material of the skin layer no longer have to be a compromise between conflicting requirements.

By “matching Young's moduli” in the present specification is meant that the Young's moduli of the skin layer and the inner core are sufficiently close numerically that the composite pipe essentially behaves as a single body under impact. Where the Young's modulus of the skin layer is less than the Young's modulus of the inner core, preferably the moduli of the inner core and the skin layer do not differ by more than 300 MPa, more preferably by not more than 150 MPa, and most preferably by not more than 50 MPa, when measured, for example, by the method of DIN 53 457-Z. Ideally the Young's moduli of the inner core and the skin layer should be identical, or nearly so.

Preferably the Young's modulus (in MPa) of the inner core is at least 900, more preferably within the range from 950 to 1350, most preferably within the range 1000 to 1250. Preferably the Young's modulus of the skin layer (in MPa) is at least 800, more preferably within the range 800 to 1350, and most preferably within the range 950 to 1250, when measured, for example, by the method of DIN 53 457-Z.

The strength of the adhesive bond between the skin layer and the inner core is preferably at least 0.1 N/mm, more preferably at least 0.2 N/mm, when measured by a rolling drum peel test as described in Appendix 1. The adhesive bond between the skin layer and the inner core is preferably less than 2.0 N/mm, more preferably less than 1.5 N/mm. Very good results have been achieved using an adhesion between the skin layer and the inner core within the range of from 0.3 to 1.5 N/mm, when measured by the above-mentioned rolling drum peel test.

Without wishing to be bound to any particular theory, it is believed that the adhesion between the high molecular weight polymers of the skin layer and the core is as a result of Van der Waals and/or diffusive bonding, or similar forces. Trhe adhesive properties of the inner bonding layer could be modified, for example, by the addition of an adhesion modifying agent such as a glycerol ester, as described in co-pending UK patent application no. (Agent's reference P071963GB).

It is likely that any adhesion between the skin layer and the inner core will have some effect upon the impact strength of the plastics pipe, and it is presumably for this reason that prior art proposals (other than GB2297137 and GB2297138) have always sought to avoid adhesion between the skin layer and the core. Nevertheless, it has been found that by matching the Young's moduli of the inner core and the skin layer and employing limited adhesion, as discussed above, there can be produced a composite plastics pipe having sufficient impact strength to meet the requirements of all available standards.

Preferably the polymeric materials of the inner core and the skin layer are matched such that the impact strength of the composite plastics pipe is at least 50%, preferably at least 75%, more preferably at least 90% of the impact strength of the inner core without the skin layer.

The inner core and the skin layer of the composite plastics pipe of the present invention can comprise any suitable thermoplastic polymeric materials, consistent with the matching of their physical and mechanical properties. Suitable polymeric materials include, for example, olefinically-unsaturated polymers and co-polymers, for example, polyolefins such as polyethylene, polypropylene, polybutene and polybutylene; ethylene and propylene co-polymers, for example, etlhylene-vinyl acetate polymers, and propylene-vinyl acetate polymers; halogenated-vinyl polymers such as vinyl chloride polymers and co-polymers; polyamides, for example, nylon 6, nylon 11 and nylon 66; polycarbonates; ABS polymers and ionomer polymers such as Surlyn (RTM).

The inner core of the pipe comprises a polymeric material chosen to be compatible with the particular application, and in particular with the fluid material to be conveyed by the pipe. For many applications polyethylene is the preferred material for the inner core. The grade of polyethylene chosen, that is to say, high density, medium density, low density, or linear low density, will depend upon the particular application. Suitable grades of polyethylene for pressure pipe. applications preferably meet the requirements of at least one of prEN 12201-1 (except clause 4.2.1 and the associated pigment or carbon black requirements if the PE material is unpigmented), prEN12201-2 (except clause 5.2 and the associated pigment or carbon black requirements if the PE material is unpigmented), prEN1555-1 (except clause 4.2.2 and the associated pigment or carbon black requirements if the PE material is unpigmented) and prEN1555-2 (except clause 5.2 and the associated pigment or carbon black requirements if the PE material is unpigmented).

Any suitable equivalent grade of polyethylene may, of course, also be used.

Preferably the inner core, where polyethylene is chosen, has an impact strength of at least 300 joules, more preferably at least 400 joules and most preferably at least 500 joules, when measured using the method of EN1411:1996 at a temperature of −10° C. using a 90 mm diameter tup for impacting the pipe.

The skin layer is formed from a polymeric material or a blend of polymeric materials having a Young's modulus matching that of the inner core. Preferred polymeric materials for the skin layer comprise propylene homo- and co-polymers, propylene block co-polymers, and propylene random co-polymers.

Preferably the skin layer has a notched Charpy impact strength of at least 1 kJ/m², more preferably at least 2 kJ/m² and most preferably at least 4 kJ/m², when measured using the method of ISO 179/16A at a temperature of −20° C.

A particularly preferred plastics pipe according to the present invention comprises an inner core of polyethylene and a skin layer of a propylene block co-polymer having matched Young's moduli.

Preferably the impact strength of a 90 mm outside diameter plastics pipe having a polyethylene inner core and a polypropylene skin layer with an SDR of 17.0 is greater than 300 joules when measured using the method of EN1411:1996 at a temperature of −10° C. using a 90 mm diameter tup for impacting the pipe.

An advantage of the plastics pipes of the present invention is that the normal UV stabiliser and colorant package need not be included in the plastics material of the inner core, provided that sufficient quantities of these materials are included in the skin layer. This enables the inner core to comprise a natural polymeric material, free or substantially free from additives which add to the cost of the core material and which, in certain circumstances, may impair the mechanical or physical properties of the core material. Alternatively, stabilisers can be included in the core material, but the outer protective skin layer can be coloured to indicate the fluid being transported within the pipe.

Suitable stabiliser or ultra-violet blocking additives include, for example, titanium dioxide, carbon black, and other fillers. Whilst carbon black is an excellent UV stabiliser and reinforcing filler, buried pipes are frequently colour coded and its use in the outer protective layer is therefore not possible for many applications. Titanium dioxide is, therefore, the preferred filler and UV stabiliser since this is also compatible with many colcorant packages. Other filler materials such as chalk and talc, may also be used. The preferred filler particle size is dependent on the filler being used, but for titanium dioxide, for example, the average particle size range is preferable from 0.003 to 0.025 microns.

The skin layer and the inner core can, of course, each comprise more than one layer of polymeric material, although in practice this is not usually necessary.

The relative thickness of the skin layer and the dimensions of the pipe have also been found to affect the impact resistance of the pipe. This is discussed in GB 2297138. Preferably the skin layer has a thickness of greater than 0.1 mm, more preferably greater than 0.2 mm, and most preferably within the range of from about 0.3 mm to 2.0 mm.

The dimensions of the pipe and the protective layer are preferably such that the ratio of the external diameter of the pipe to the thickness of the skin layer is at least 70, more preferably at least 100, most preferably in the range 150 to 800. From this it can be seen that it is possible to use a thicker skin layer on a pipe of greater diameter.

When stripping the skin layer from the pipe, it is important that no residue or holidays should be left on the pipe surface that could interfere with the electrofusion jointing process. Thus conventional adhesives and skin layers that are prone to tearing or fragmentation should be avoided. In general the force required to rupture the skin layer should be greater than the force required to peel the skin layer from the inner core.

By “a clean surface” in this specification is meant a pipe surface that can be subjected to electrofusion jointing without further preparation or treatment. Such surfaces should meet the requirements of one or more of pr EN12201 part 3, pr EN1555 part 3 and WIS 04-32-14.

The composite plastics pipe of the present invention is preferably produced by co-extrusion, wherein the polymeric materials are brought together in the pressure area of the die and exit as a single extrudate. For example, the die may be connected to one, two, or more extruders and fed with separate streams of molten material. Alternatively, the die may be provided with concentric die outlets fed with separate streams of molten polymeric materials which are to form the inner core and the skin layer. In this case, the extrudates, on leaving the extruder die outlets, can be brought into contact with each other in a sizing die which simultaneously adjusts the outer diatmeter of the pipe.

In a further alternative, the inner core extrudate may be passed through a sizing die before applying the skin layer. In this case it may be necessary to re-heat or flame-brush the surface of the inner core extrudate to create a surface ready to receive the skin layer. Because of the difficulty of maintaining a consistent adhesion between the inner core and the skin layer, this method is not presently preferred.

The invention is illustrated by the following Example:

### EXAMPLE

A polyethylene core pipe of nomimal outer diameter 90mm was co-extruded with a propylene random copolymer skin layer. The experiment was repeated replacing the propylene random copolymer with a propylene block copolymer.

Skin adhesion was measured using a rolling drum peel test as described in Appendix 1.

The skin layers of the resultant pipes could be peeled readily using a simple hand tool, exposing a clean surface of the core pipe. Electrofusion jointing tests gave very good results in conformance with prEN12201 part 3, prEN1555 part 3 and WIS 04-32-14.

The impact strength cuf the pipes was measured at −10° C., with and without the skin layer, using the method of EN 1411:1996. In further experiments the pipes were notched at 90° to the point of impact prior to testing to simulate service conditions. The results are given in Table 1.

TABLE 1

PIPE

| | 1 | 2 |
|---|---|---|
| Ø(MM)-SDR | 90-17 | 90-17 |
| CORE resin | Polyethylene | Polyethylene |
| Young's modulus MPa | 1150 | 1150 |
| SKIN resin | Propylene | Propylene |
| | random | block |
| | copolymer | copolymer |
| Thickness (mm) | 0.5-1.0 | 0.67 |
| Young's modulus MPa | 900 | 1100 |
| SKIN ADHESION | | |
| Min(N/mm) | 0.3 | 1.08 |
| Mean (N/mm) | — | 1.55 |
| Max (N/mm) | 0.8 | 1.96 |
| IMPACT at −10° C. | | |
| Un-Notched (J) | 103-324 | >588 |
| No skin, un-notched (J) | 487-588 | |
| Notched to 0.2 mm | 103 | 333* |
| depth (J) | | |
| No Skin, notched (J) | 387 | |

*Passed if the skin breaks but the core remains intact.

The results show that by matching the Young's moduli of a propylene copolymer skin layer to a polyethylene core, the impact strength of the pipe can be made comparable to a similar pipe without a skin layer, whilst the peelability of the pipe is retained.

APPENDIX 1

DETERMINATION OF THE ADHESION STRENGTH OF PIPE SKIN—CORE PEEL

Apparatus

A tensile testing machine accurate to grade A of BS5214 Part 1: 1975 or grade 1 of BS1610: Part 1: 1985, for example, a Lloyds tensile test machine, using a 100N load cell.

Test Specimens

Two test pieces are cut one from each end of the sample pipe, 25 mm +/−2mm wide, the two sample rings of pipe are trimmed around the circumference to remove the jagged edge. The pipe is marked along top dead centre (TDC) of the extrusion line (if known).

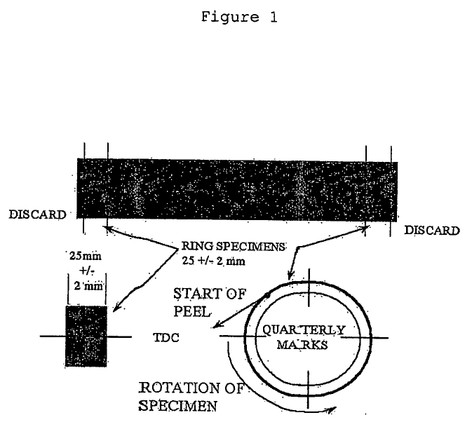

The two ring specimens are marked with an indelible marker at quarterly points around the circumference beginning at TDC (if known), as illustrated in FIG. 1.

Procedure

Cut through the skin along mark at TDC & prise edge of skin from pipe, peel skin off to 30-40 mm length, feed peeled skin through the jig as shown & clamp in upper jaws.

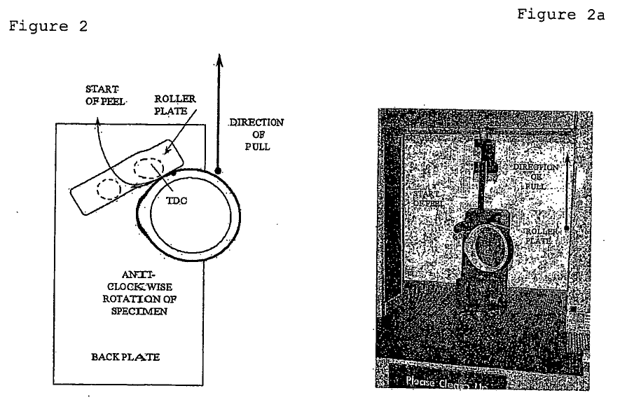

Mount the test piece in the jig as shown in FIGS. 2 and 2a.

The skin is then peeled from the pipe at a separation rate of 100 mm/min and a trace recorded of load versus time.

The average value of the load required to peel the skin sample is calculated (Newtons), and divided by the true width of the peel sample to obtain the test result (Newtons/millimetre)

The average of the 10 peak load values recorded is calculated (Newtons), and divided by the true width of the peel sample to obtain the test result (Newtons/millimetre).

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A plastics pipe which comprises an inner core and an outer removable skin layer bonded thereto, wherein
the inner core an the outer removable skin layer comprise polymeric materials chosen to have matching Young's moduli, such that the Young's modulus of the skin layer is equal to or less than the Young's modulus of the inner core, and
the adhesion of the skin layer to the inner core is sufficient to prevent substantial undesired relative movement between the skin layer and the core during installation, but insufficient to prevent the outer skin layer from being cleanly removed by peeling, at least at the ends of the pipe, and insufficient to cause a substantial reduction in the impact strength of the inner core.

2. A plastics pipe according to claim 1, wherein when the Young's modulus of the skin layer is less than the Young's modulus of the inner core, the moduli of the inner core and the skin layer do not differ by more than 150 MPa, when measured by the method of DIN 53 457-Z.

3. A plastics pipe according to claim 1, wherein the moduli of the inner core and the skin layer do not differ by more than 50 MPa, when measured by the method of DIN 53 457-Z.

4. A plastics pipe according to claim 1, wherein the Young's modulus of the inner core is within the range from 950 to 1350 MPa.

5. A plastics pipe according to claim 1, wherein the Young's modulus of the skin layer is within the range from 800 to 1350 MPa.

6. A plastics pipe according to claim 1, wherein the strength of the adhesive bond between the skin layer and the inner core is from 0.3 N/mm to 1.5 N/mm, when measured by a rolling drum peel test as described in Appendix 1.

7. A plastics pipe according to claim 1, in which the strength of the adhesive bond between the skin layer and the inner core is such that the impact strength of the composite pipe is at least 75% of the impact strength of the inner core without the skin layer.

8. A plastics pipe according to claim 1, in which the inner core comprises polyethylene.

9. A plastics pipe according to claim 1, wherein the skin layer comprises a propylene homo- or co-polymer, or a propylene block co-polymer.

10. A plastics pipe according to claim 9, wherein the skin layer comprises a propylene block co-polymer.

11. A plastics pipe according to claim 1, in which the inner core comprises polyethylene and the skin layer comprises a propylene co-polymer and wherein the impact strength of the pipe is greater than 300 joules, when measured using the method of EN1411:1996 at a temperature of −10° C. using a 90mm tup for impacting the pipe.

12. A plastics pipe according to claim 1, wherein the skin layer has a thickness within the range of from 0.3 mm to 2.0 mm.

13. A plastics pipe according to claim 1, wherein the ratio of the external diameter of the pipe to the thickness of the skin layer is from 150 to 800.

14. A method for the production of a plastics pipe comprising an inner core and an outer removable skin layer bonded thereto, the inner core and the outer removable skin layer comprising polymeric materials chosen to have matched Young's moduli, such that the Young's modulus of the skin layer is equal to or less than the Young's modulus of the inner core, which method comprises co-extruding molten polymeric materials forming the inner core and the outer removable skin layer from one or more extruder dies, bringing the molten polymeric materials together and allowing them to cool, such that, on cooling, the adhesion of the skin layer to the inner core is sufficient to prevent substantial undesired relative movement between the skin layer and the core during installation of the pipe, but insufficient to prevent the skin layer from being cleanly removed by peeling, at least at thee ends of the pipe, and insufficient to cause a substantial reduction in the impact strength of the inner core.

15. A method according to claim 14, wherein the polymeric materials of the inner core and the outer removable skin layer are extruded simultaneously and brought together whilst still hot.

16. (canceled)

17. A method of making a joint to a plastics pipe according to claim 1, or of joining two such plastics pipes, which comprises peeling the skin layer from the region or regions of the pipe to be joined, to expose a clean surface suitable for electrofusion jointing, installing an electrofusion coupler over the clean surface or surfaces of the pipe or pipes and activating the electrofusion coupler to fuse the region or regions of the pipe or pipes thereto.
